(19) United States
(12) Patent Application Publication
(10) Pub. No.: US 2012/0255193 A1
(43) Pub. Date: Oct. 11, 2012

(54) SUBSTRATE DRYING APPARATUS AND METHOD

(75) Inventor: Akitake Tamura, Nirasaki City (JP)

(73) Assignee: TOKYO ELECTRON LIMITED, Tokyo (JP)

(21) Appl. No.: 13/518,631

(22) PCT Filed: Dec. 7, 2010
(86) PCT No.: PCT/JP10/71855

§ 371 Date: Jun. 25, 2012

(30) Foreign Application Priority Data
Dec. 25, 2009 (JP) 2009-295503

(51) Int. Cl. F26B 25/00

(52) U.S. Cl. 34/397; 34/236

(57) ABSTRACT

A substrate drying apparatus which dries a substrate cleaned by a diamagnetic liquid includes a magnet unit for moving the liquid adhering to the substrate by means of a magnetic force; and a magnet transfer mechanism for moving the magnet unit along the substrate toward an edge of the substrate. A substrate drying method of drying a substrate cleaned by a diamagnetic liquid includes bringing a magnet unit close to the substrate, the magnet unit being configured to move the liquid adhering to the substrate by means of a magnetic force; and moving the magnet unit along the substrate toward the edge of the substrate.

This application is a Continuation Application of PCT International Application No. PCT/JP2010/071855 filed on Dec. 7, 2010, which designated the United States.

### FIELD OF THE INVENTION

The present invention relates to a substrate drying apparatus and method which dries a substrate cleaned with a diamagnetic liquid by using a magnet.

### BACKGROUND OF THE INVENTION

In a semiconductor device manufacturing process, there is used a substrate drying apparatus in which a semiconductor wafer (hereinafter, referred to as a “wafer”) is held by using a spin chuck and the wafer is cleaned by supplying a liquid chemical thereto. In a cleaning process using such an apparatus, liquid chemical or deionized water is supplied to the wafer and, then, the wafer is dried by removing liquid droplets by a centrifugal force generated by rotating the wafer.

As for the method for drying a wafer, there is suggested a method in which, while rotating the wafer, vapor or mist of IPA (isopropyl alcohol) or the like is injected to the wafer, or IPA liquid or the like is supplied to the wafer. There is also suggested a Marangoni drying method of drying a wafer by injecting vapor of IPA or the like while supplying deionized water to the wafer from a nozzle moving from a center to an edge of the wafer, the vapor being injected to a portion closer to the center of the wafer than the portion to which the deionized water is supplied (see, e.g., Japanese Patent Application Publication No. 2007-36180).

When an IPA gas is injected to the wafer, the IPA gas is locally solved on a water surface on the wafer, thereby generating Marangoni convection caused by concentration difference. Accordingly, there occurs water flow on a gas-liquid interface, so that minute liquid droplets may be prevented from being produced by being separated from water drops.

However, once the minute liquid droplets are produced from the water drops adhering to the wafer, a force generated by the Marangoni convection is not applied to the minute liquid droplets. Therefore, the minute liquid droplets cannot be moved and may remain on the wafer surface. When the minute liquid droplets remaining on the wafer are dried, wafer marks (particles produced by the precipitation of liquid chemical or the like) are generated on the wafer surface.

### SUMMARY OF THE INVENTION

In view of the above, the present invention provides an apparatus and method for drying a substrate, capable of more effectively preventing liquid droplets from remaining on a substrate, e.g., a wafer or the like and suppressing generation of water marks by moving a magnet unit along the substrate toward an edge thereof, in comparison to the Marangoni drying method.

In accordance with an aspect of the present invention, there is provided a substrate drying apparatus which dries a substrate cleaned by a diamagnetic liquid, including a magnet unit for moving the liquid adhering to the substrate by means of a magnetic force; and a magnet transfer mechanism for moving the magnet unit along the substrate toward an edge of the substrate.

The apparatus may further includes a spin chuck for supporting and rotating the substrate of a circular plate shape, wherein the magnet transfer mechanism includes a transfer unit for moving the magnet unit along the substrate from a region near a substantially central portion of the substrate toward a region diametrically outside of the substrate.

The magnet unit may have a first and a second magnet facing each other polarities of facing magnetic poles of the first and the second magnet being opposite to each other, and a facing direction of the first and the second magnet may be in a non-parallel relationship with a rotation shaft of the spin chuck.

The apparatus may further include an approaching/separating unit for bringing the first and the second magnet close to or away from each other.

The approaching/separating unit may include a unit for bringing the first and the second magnet close to each other at the region near the substantially central portion of the substrate.

The apparatus may further includes arm units for supporting the first magnet and the second magnet such that the first magnet faces one surface of the substrate supported by the spin chuck and the second magnet faces another surface of the substrate; and a column for supporting the arm units, wherein the approaching/separating unit has an elevation unit for vertically moving the arm units along the column.

The apparatus may further include a drying gas supply nozzle through which a drying gas is supplied to the substrate, wherein the first magnet has an opening that opens in the facing direction, and the drying gas supply nozzle is inserted into the opening.

In accordance with another aspect of the present invention, there is provided a substrate drying method of drying a substrate cleaned by a diamagnetic liquid, including bringing a magnet unit close to the substrate, the magnet unit being configured to move the liquid adhering to the substrate by means of a magnetic force; and moving the magnet unit along the substrate toward the edge of the substrate.

In accordance with still anther aspect of the present invention, there is provided a substrate drying method of drying a substrate cleaned by a diamagnetic liquid, including rotating the substrate of a circular plate shape; bringing a magnet unit close to a region near a substantially central portion of the substrate, the magnet unit being configured to move the liquid adhering to the substrate by means of a magnetic force; and moving the magnet unit along the substrate from the region near the substantially central portion of the substrate toward a region diametrically outside of the substrate.

In accordance with the aspects of the present invention, when the magnet unit is moved toward the edge of the substrate along the substrate where the diamagnetic liquid is adhered toward, the liquid adhering to the substrate is also moved toward the edge of the substrate. Hence, the liquid can be removed from the substrate. In other words, the substrate can be dried.

The magnetic force caused by the diamagnetism of the liquid adhering to the substrate acts on the entire liquid, so that the minute liquid droplets are also moved toward the edge of the substrate by the magnetic force. Further, when large liquid droplets adhering to the substrate are moved toward the edge of the substrate, the minute liquid droplets may lag behind. However, when the magnet unit moving toward the edge of the substrate is brought close to the minute liquid droplets that have lagged behind, the larger magnetic force acts on the lagged minute liquid droplets as compared to the large liquid droplets moved toward the edge of the substrate. Hence, the minute liquid droplets can be moved toward the large liquid droplets and mixed therewith. Accordingly, the minute liquid droplets remaining on the substrate can be reduced more effectively in comparison to the Marangoni drying method.

In accordance with the aspects of the present invention, the liquid adhering to the substrate is moved toward the region diametrically outside of the substrate by a centrifugal force produced by rotating a circular plate-shaped substrate supported by a spin chuck. By moving the magnet unit from the region near the approximately central portion of the substrate toward the region diametrically outside of the substrate, the liquid adhering to the substrate is moved toward the region diametrically outside thereof. Thus, the liquid is more effectively removed from the substrate.

In accordance with the aspects of the present invention, the direction of the first and the second magnet facing each other is in a non-parallel relationship with a rotation shaft of the spin chuck. Hence, the first and the second magnet can face each other at the region near the substantially central portion of the circular plate-shaped substrate without being blocked by the rotation shaft of the spin chuck, and the magnetic force of the magnet unit can act on the corresponding central portion.

In accordance with the aspects of the present invention, the first and the second magnet are brought close to each other in such a way that the substrate is positioned therebetween, so that the liquid adhering to the substrate inserted between the first and the second magnet can be moved toward outside of the substrate by the magnetic force caused by the diamagnetism.

In accordance with the aspects of the present invention, by bringing the first and the second magnet close to each other at the substantially central portion of the substrate, the liquid adhering to the region near the substantially central portion of the substrate inserted between the first and the second magnet can be moved toward outside of the corresponding central portion.

In accordance with the aspects of the present invention, the first and the second magnet are brought close to or away from each other by vertically moving the arm unit supported by the column.

In accordance with the aspects of the present invention, the liquid can be more effectively removed from the substrate by supplying a drying gas to the substrate from the drying gas supply nozzle provided at the first magnet.

In accordance with the present invention, it is possible to more effectively prevent liquid droplets from remaining on a substrate and suppress generation of water marks in comparison to the Marangoni drying method.

### BRIEF DESCRIPTION OF THE DRAWINGS

The objects and features of the present invention will become apparent from the following description of embodiments, given in conjunction with the accompanying drawings, in which:

FIG. 1 is a vertical cross sectional view schematically showing a configuration of a substrate drying apparatus in accordance with an embodiment of the present invention;

FIG. 2 is a cross sectional view taken along line II-II of FIG. 1;

FIG. 3 is a perspective view schematically showing a configuration of a magnet unit;

FIG. 4 is a vertical cross sectional view schematically showing the configuration of the magnet unit;

FIG. 5 is a vertical cross sectional view schematically showing a configuration of a substrate drying apparatus which is in a state where the magnet unit is moved to a portion outside of a wafer;

FIG. 6 is a vertical cross sectional view schematically showing a configuration of a substrate drying apparatus which is in a state where magnets are separated from each other;

FIGS. 7A to 7E conceptually explain a substrate drying method;

FIG. 8 is a flow chart showing a processing sequence of a control unit;

FIGS. 9 to 10B conceptually explain a principal of the substrate drying method; and

FIG. 11 is a perspective view schematically showing a configuration of a magnet unit in accordance with a modification.

### DETAILED DESCRIPTION OF THE EMBODIMENTS

Hereinafter, the present invention will be described in detail with reference to the accompanying drawings which described embodiments of the invention. A substrate drying apparatus in accordance with an embodiment of the present invention is an apparatus which cleans and dries a wafer (substrate), and effectively prevents generation of water marks especially by using a magnet.

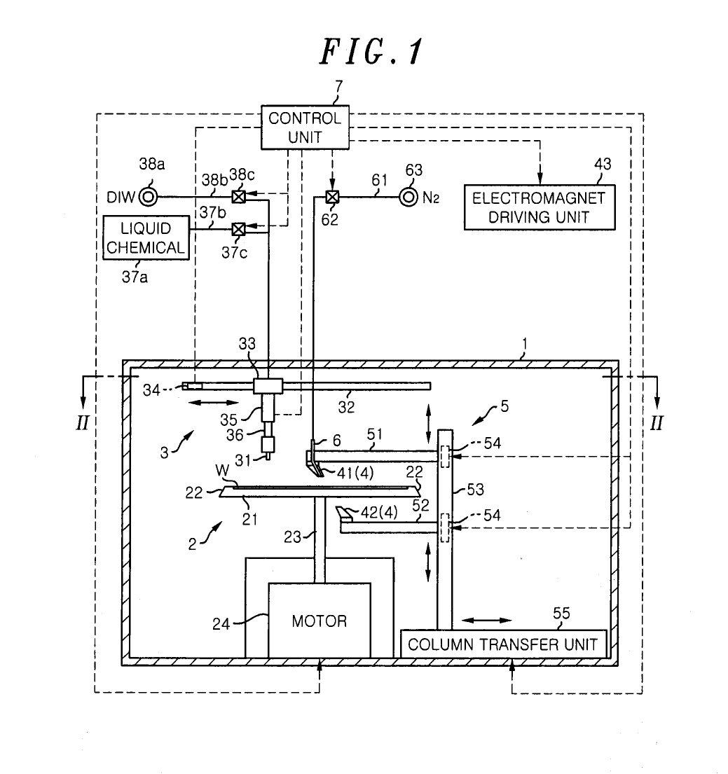

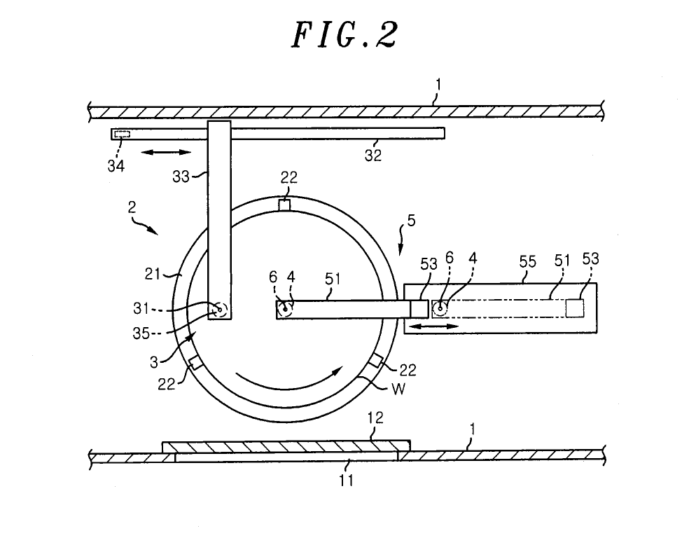

FIG. 1 is a vertical cross sectional view schematically showing a configuration of a substrate drying apparatus in accordance with an embodiment of the present invention. FIG. 2 is a cross sectional view taken along line II-II of FIG. 1. The substrate drying apparatus includes a hollow processing chamber 1 having an approximately rectangular parallelepiped shape. As shown in FIG. 2, a loading/unloading port 11 is provided to the processing chamber 1 to load and unload a wafer W into and from a processing space therein. By closing the loading/unloading port 11 by a door body 12, the processing space can be airtightly sealed.

Provided in the processing chamber 1 is a spin chuck 2 on which an approximately circular plate-shaped wafer W is approximately horizontally supported and rotated. The spin chuck 2 has a table 21 on which the wafer W is mounted. As shown in FIG. 2, three support members 22 are provided at an upper portion of the table 21, and the wafer W is approximately horizontally supported by bringing the support members 22 into contact with three locations at the peripheral portion of the wafer W. The table 21 has a rotation shaft 23 projecting downward from an approximately central portion thereof, and a lower end portion of the rotation shaft 23 is connected to a motor 24 for rotating the table 21 about an approximately vertical axis.

When the table 21 is rotated by driving the motor 24, the wafer W is rotated together with the table 21 about the approximately central portion of the wafer W as the center of rotation in an approximately horizontal plane. In the illustrated example, the wafer W is rotated in a counterclockwise direction when viewed from above. The driving of the motor 24 is controlled by a control unit 7.

A liquid supply unit 3 for supplying a cleaning liquid is provided at an upper portion of the processing chamber 1. The liquid supply unit 3 includes a nozzle 31 through which a cleaning liquid chemical and a rinse (a diamagnetic liquid) are supplied to the wafer W. The liquid chemical is, e.g., dilute hydrofluoric acid (DHF), and the rinse is, e.g., deionized water (DIW). The nozzle 31 is held by a nozzle arm 33.

The nozzle arm 33 is provided above the wafer W supported by the spin chuck 2. A base end portion of the nozzle arm 33 is held to be movable along a guide rail 32 that is disposed substantially horizontally. Further, a driving unit 34 for moving the nozzle arm 33 along the guide rail 32 is provided. With the driving of the driving unit 34, the nozzle arm 33 can be moved between a space above the wafer W supported by the spin chuck 2 and a space above the outside of the peripheral edge of the wafer W (left side in FIG. 1). Along with the movement of the nozzle arm 33, the nozzle 31 can be moved relative to the wafer W from the space above the substantially central portion of the wafer W toward the space above the peripheral edge of the wafer W. The operation of the driving unit 34 is controlled by the control unit 7.

The nozzle 31 is attached to a lower end of an elevation shaft 36 projecting downward from a nozzle elevation unit 35 fixed to the bottom surface of a leading end of the nozzle arm 33. The elevation shaft 36 can be vertically moved by the nozzle elevation unit 35, so that the nozzle 31 can be vertically moved to a desired height. The driving of the nozzle elevation unit 35 is controlled by the control unit 7.

The nozzle 31 is connected to a liquid chemical supply line 37b connected to a liquid chemical supply source 37a and a rinse supply line 38b connected to a rinse supply source 38a. The liquid chemical supply line 37b and the rinse supply line 38b are provided with opening/closing valves 37c and 38c, respectively. The opening/closing operations of the opening/closing valves 37c and 38c are controlled by the control unit 7.

The substrate drying apparatus includes a magnet unit 4 for moving liquid adhering to the wafer W by a magnetic force and a magnet transfer unit 5 for moving the magnet unit 4 along the wafer W toward the edge side of the wafer W.

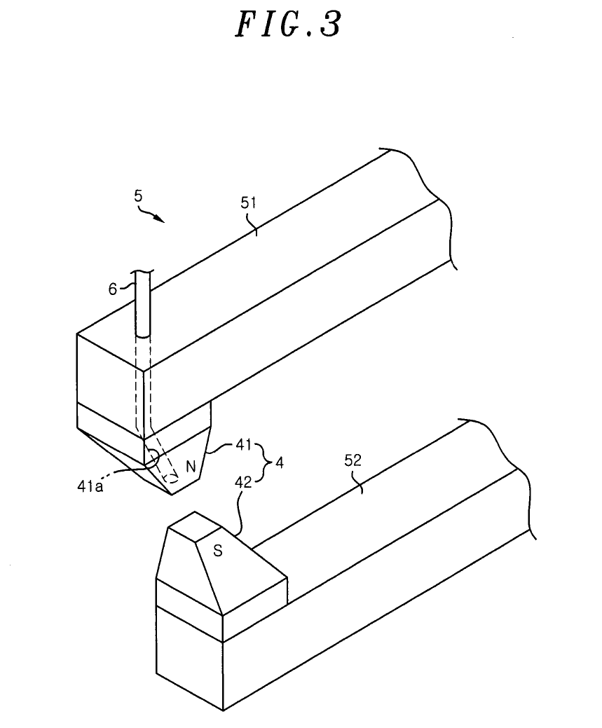

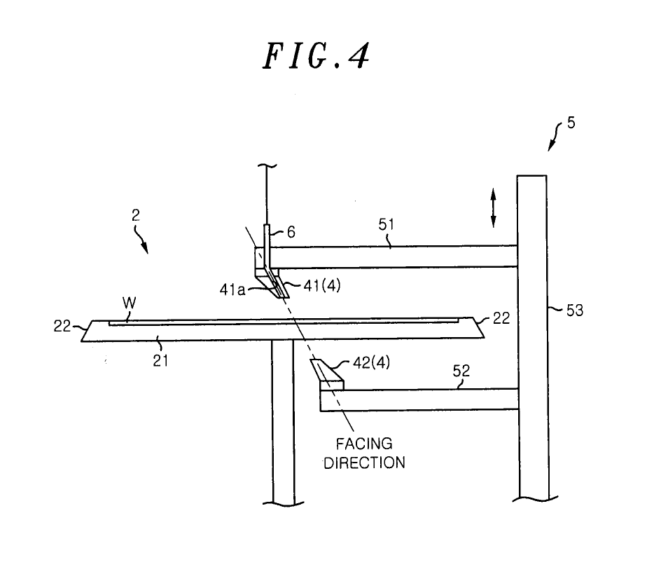

FIG. 3 is a perspective view schematically showing a configuration of the magnet unit 4. FIG. 4 is a vertical cross sectional view schematically showing the configuration of the magnet unit 4. The magnet unit 4 has a pair of a first magnet 41 and a second magnet 42. Each of the first and the second magnet 41 and 42 is the electromagnet that has a truncated quadrangular pyramid shape with its leading end portion cut away and is driven by an electromagnet driving unit 43, wherein polarities of the facing magnetic poles of the magnets 41 and 42 are opposite to each other. Moreover, an opening 41a for a drying gas supply nozzle 6 to be described later is formed in the first magnet 41 in a facing direction of the first magnet 41 and the second magnet 42.

The magnet transfer unit 5 includes: a first and a second arm unit 51 and 52 supporting the magnet unit 4; a column 53, provided in a substantially vertical direction with respect to the bottom surface of the processing chamber 1, and supporting the first and the second arm unit 51 and 52; an elevation unit 54 for vertically moving the arm units 51 and 52 along the column 53; and a column transfer unit 55.

The first arm unit 51 has a prism shape and is attached to the column 53 above the table 21 its lengthwise direction being arranged substantially horizontally. The first arm unit 51 supports the first magnet 41 at the bottom surface of the leading end thereof such that the magnetic pole of the first magnet 41 faces slantingly downward.

The second arm unit 52 has a prism shape as in the first arm unit 51 and is attached to the column 53 below the table 21 with its lengthwise direction being arranged substantially horizontally. The second arm unit 52 supports the second magnet 42 at the top surface of the leading end thereof such that the leading end of the second magnet 42 faces slantingly upward and the facing direction of the first and the second magnet 41 and 42 is in a non-parallel relationship with the rotation shaft 23 of the spin chuck 2.

The elevation unit 54 vertically moves the first and the second arm unit 51 and 52 in unison such that the first and the second magnet 41 and 42 are brought close to or away from each other. The elevation unit 54 includes, e.g., a linear motor. The linear motor includes a shaft disposed along the column 53; and pipe-shape sliders respectively provided in the first and the second arm units 51 and 52, to be moved along the shaft. The shaft has a structure in which N poles and S poles are arranged alternately along a transfer direction of the sliders. The slider has a housing made of a non-magnetic material, and the housing has electromagnets disposed therein so as to surround the shaft. By supplying currents to coils of the electromagnets, the first and the second arm unit 51 and 52 can be vertically moved. The operation of the elevation unit 54 is controlled by the control unit 7.

The column transfer unit 55 serves to linearly reciprocate the column 53 along the diametrical direction of the wafer W supported by the spin chuck 2 such that the first and the second magnet 41 and 42 move back and forth between a region near a substantially central portion of the wafer W and a region diametrically outside of the wafer W. The column transfer unit 55 includes, e.g., a linear motor. The operation of the column transfer unit 55 is controlled by the control unit 7.

Further, the substrate drying apparatus includes the drying gas supply nozzle 6 through which a drying gas is supplied to the wafer W. The first magnet 41 has the opening 41a that opens in the facing direction, and the drying gas supply nozzle 6 is inserted into the opening 41a. A drying gas supply line 61 connected to a drying gas supply source 63 is connected to the drying gas supply nozzle 6. The drying gas supply line 61 is provided with an opening/closing valve 62. The opening/closing operation of the opening/closing valve 62 is controlled by the control unit 7.

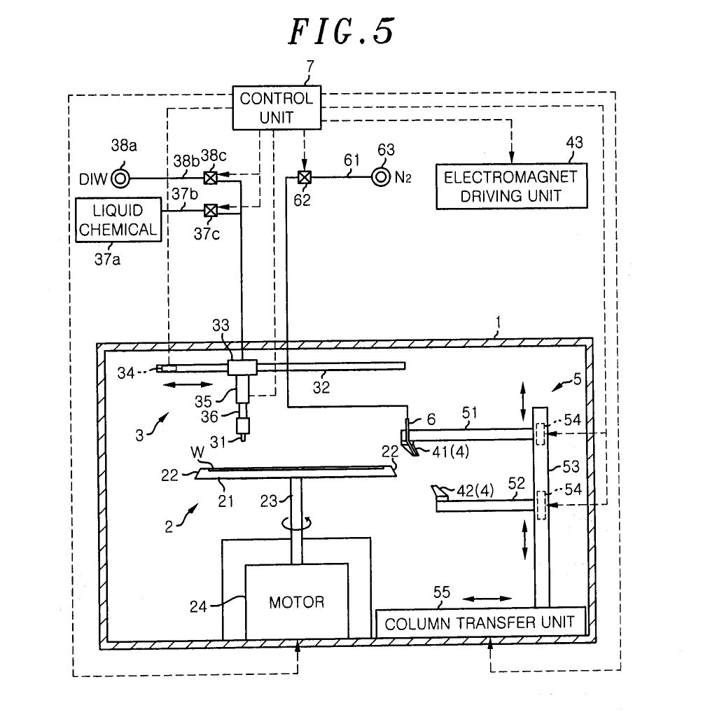

FIG. 5 is a vertical cross sectional view schematically showing a configuration of the substrate drying apparatus in a state where the magnet unit 4 is moved to the region diametrically outside of the wafer W. FIG. 6 is a vertical cross sectional view schematically showing a configuration of a substrate drying apparatus in a state where the magnets 41 and 42 are separated from each other.

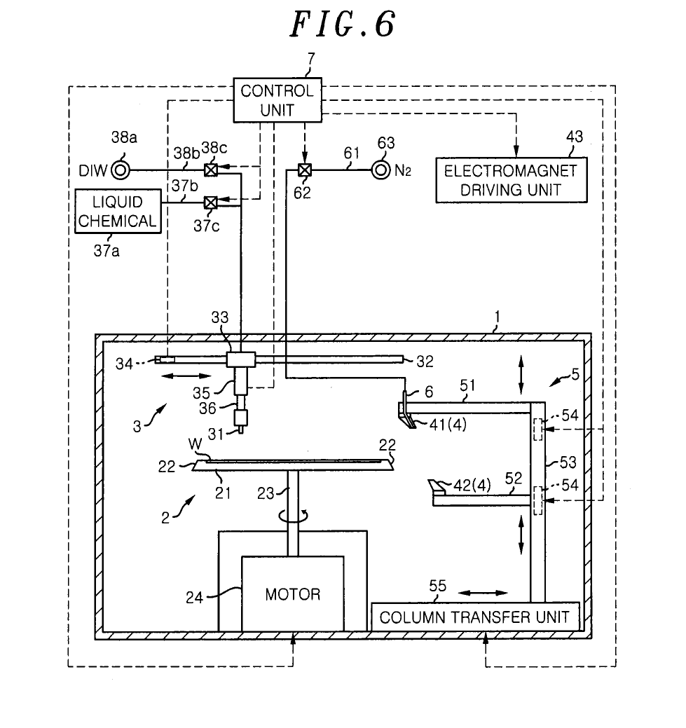

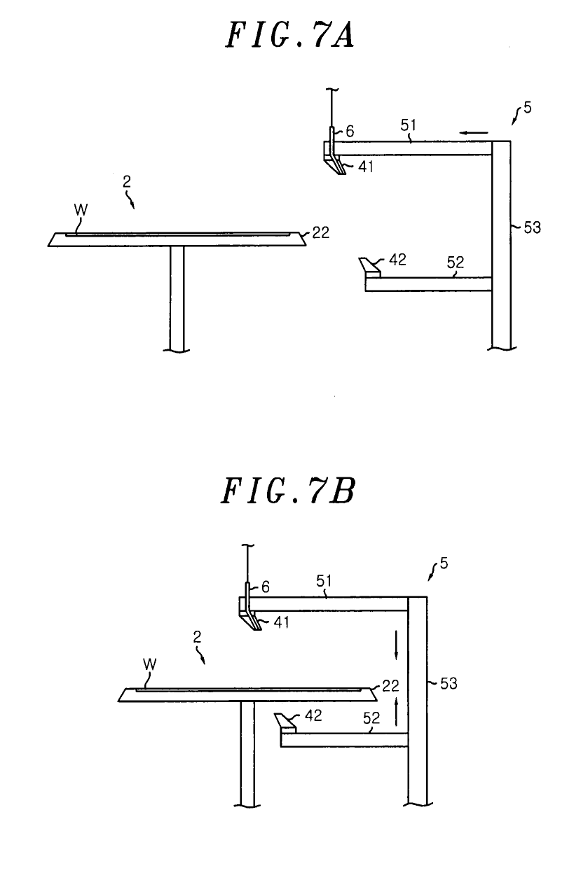

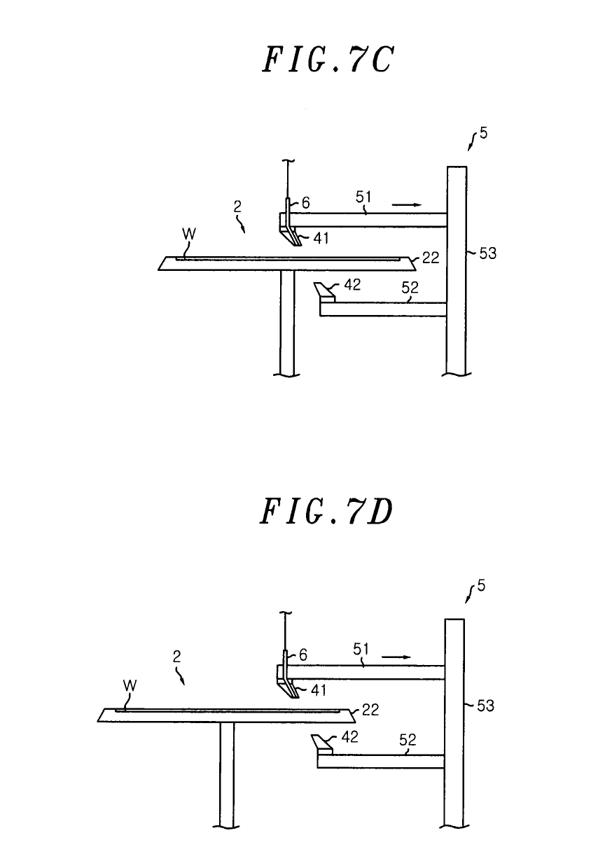

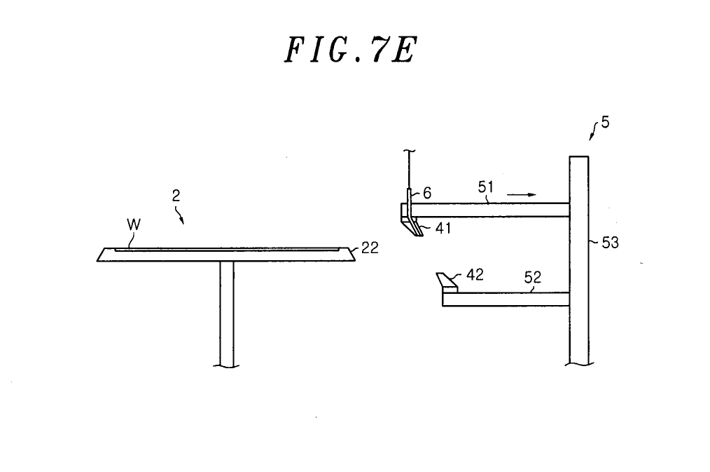

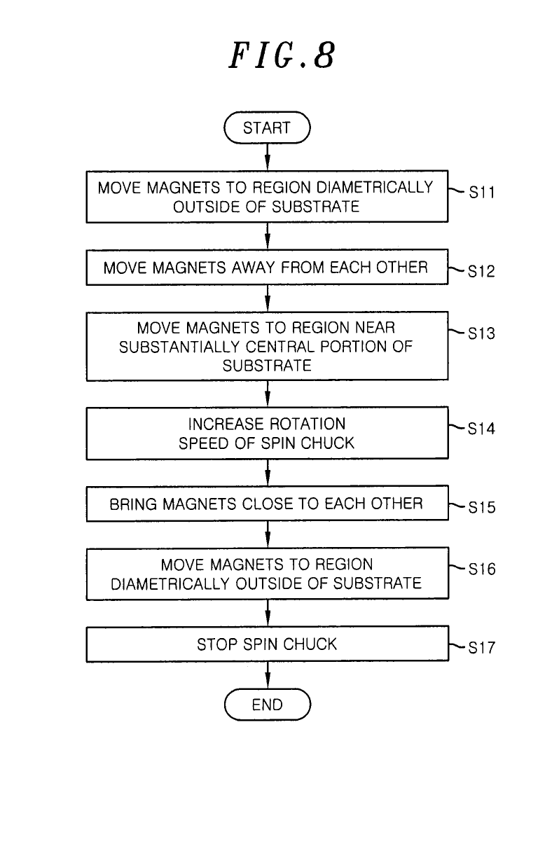

FIGS. 7A to 7E conceptually explain a substrate dying method for drying a substrate. FIG. 8 is a flow chart showing a processing sequence of the control unit 7. As shown FIG. 7A, the control unit 7 moves the magnet unit 4 to the region diametrically outside of the wafer W (step S11) and, then, moves the first and the second magnet 41 and 42 away from each other (step S12).

Next, as shown in FIG. 7B, the control unit 7 moves the first and the second magnet 41 and 42 to the region near the substantially central portion of the wafer W (step S13). Next, the control unit 7 increases the rotation speed of the spin chuck 2 (step S14).

Next, as shown in FIG. 7C, the control unit 7 brings the first and the second magnet 41 and 42 closer to each other (step S15). When the first and the second magnet 41 and 42 are brought close to each other, the control unit 7 opens the opening/closing valve 62 to supply the drying gas to the wafer W. By bringing the first and the second magnet and 42 close to each other at the region near the substantially central portion of the wafer W, it is possible to effectively prevent minute liquid droplets of the rinse from remaining on the substantially central portion of the wafer W.

As shown in FIG. 7D, the control unit 7 moves the first and the second magnet 41 and 42 to the region diametrically outside of the wafer W (step S16). By moving the first and the second magnet 41 and 42 from the substantially central portion of the wafer W to the region diametrically outside thereof, it is possible to effectively prevent the minute liquid droplets of the rinse from remaining on the wafer W. When the first and the second magnet 41 and 42 are moved to the region diametrically outside of the wafer W as shown in FIG. 7E, the control unit stops the spin chuck 2 (step S17) and completes the processing.

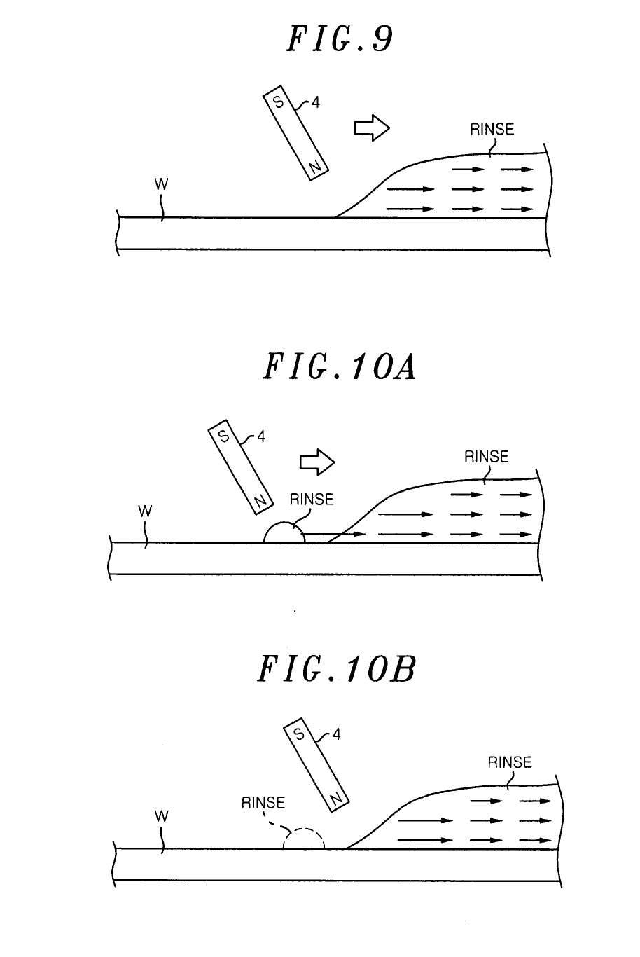

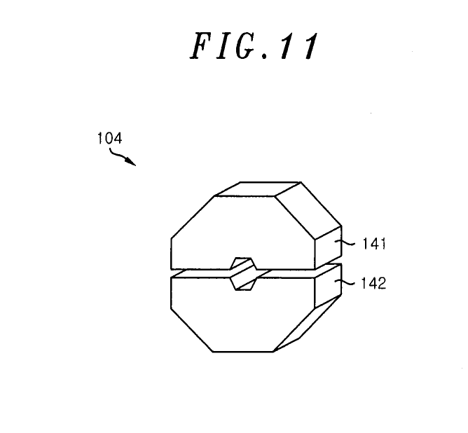

FIGS. 9, 10A and 10B conceptually explain a method for drying a substrate. In the drawings, white arrows indicate a movement direction of the magnet unit 4, and fine-line arrows indicate a magnetic force acting on the rinse due to diamagnetism. As shown in FIG. 9, when the magnet unit 4 is moved along the wafer W toward the edge of the wafer W and positioned near the rinse, e.g., when the N pole of the magnet unit 4 is positioned near the rinse, the diamagnetic rinse obtains a magnetism having an S pole at the side of the N pole of the magnet unit 4. Therefore, the rinse adhering to the wafer W is moved toward the edge of the wafer W by the magnetic force caused by the diamagnetism. As a result, the rinse can be removed from the wafer W.

When liquid droplets of the rinse adhering to the wafer W are moved toward the edge of the wafer W by the centrifugal force produced by the rotation of the spin chuck 2 as shown in FIG. 10A, minute liquid droplets of the rinse may lag behind. However, when the magnet unit 4 is moved along the wafer W toward the edge of the wafer W and positioned near the minute liquid droplets, the minute liquid droplets can return to large rinse liquid droplets and be mixed therewith, as shown in FIG. 10B.

The magnetic force caused by the diamagnetism of the rinse adhering to the wafer W acts on the entire rinse, so that the minute liquid droplets can also be moved toward the edge of the wafer W. Further, when the magnet unit 4 is brought close to the minute liquid droplets that have lagged behind, a large magnetic force acts on these minute liquid droplets and, thus, the minute liquid droplets can return to the large liquid droplets. As a result, the minute liquid droplets of the rinse remaining on the wafer W can be reduced in comparison to the conventional Marangoni drying method.

In the present embodiment, it is possible to more effectively prevent liquid droplets from remaining on the wafer W and suppressing generation of water marks in comparison to the Marangoni drying method.

By rotating the wafer W supported on the spin chuck 2 and moving the magnet unit 4 from the region near the substantially central portion of the wafer W to the portion diametrically outside of the wafer W, the rinse can be effectively removed from the wafer W and the wafer W can be dried without leaving the minute liquid droplets of the rinse.

Besides, the facing direction of the first and the second magnets 41 and 42 is in a non-parallel relationship with the rotation shaft 23 of the spin chuck 2. Therefore, the first and the second magnet 41 and 42 can be brought to close to each other near the substantially central portion of the wafer W without being blocked by the rotation shaft 23 of the spin chuck 2 and the rinse can be removed by applying the magnetic force of the magnet unit 4 to the corresponding central portion.

Further, by supplying the drying gas to the wafer W from the drying gas supply nozzle 6 provided at the first magnet 41, the rinse can be more effectively removed from the wafer W.

### Modified Embodiment

FIG. 11 is a perspective view schematically showing a configuration of the magnet unit 4 in accordance with the modified embodiment. Although the magnet unit 4 including pole piece magnets has been described in the above embodiment, a magnet unit 104 having a first and a second Halbach magnet 141 and 142 may also be used. Each of the first and the second magnet 141 and 142 has a shape of one-half of a hexagonal prism. The Halbach type magnet unit 104 is described in, e.g., Japanese Patent Application Publication No. 2000-243621, so that detailed description thereof will be omitted.

The shape of the magnet is not limited thereto, and different shape may also be employed as long as a magnetic force caused by the diamagnetism can be applied to the rinse adhering to the wafer.

Although the wafer has been described as an example of a target substrate to be dried, the present invention may also be applied to different substrate, e.g., a glass substrate that requires cleaning.

The embodiment and the modified embodiment have described the examples in which the drying method using spin drying and the drying gas and the drying method using the magnets of the embodiments are combined. However, the drying method using the magnets is not necessarily combined with such a drying method, and different drying methods may also be combined instead.

The above-described embodiments are only examples in all aspects and should not be interpreted limitedly. While the invention has been shown and described with respect to the embodiments, it will be understood by those skilled in the art that various changes and modifications may be made without departing from the scope of the invention as defined in the following claims.

What is claimed is:

1. A substrate drying apparatus which dries a substrate cleaned by a diamagnetic liquid, comprising:
a magnet unit for moving the liquid adhering to the substrate by means of a magnetic force; and
a magnet transfer mechanism for moving the magnet unit along the substrate toward an edge of the substrate.

2. The apparatus of claim 1, further comprising:
a spin chuck for supporting and rotating the substrate of a circular plate shape,
wherein the magnet transfer mechanism includes a transfer unit for moving the magnet unit along the substrate from a region near a substantially central portion of the substrate toward a region diametrically outside of the substrate.

3. The apparatus of claim 2, wherein the magnet unit has a first and a second magnet facing each other, polarities of facing magnetic poles of the first and the second magnet being opposite to each other, and a facing direction of the first and the second magnet is in a non-parallel relationship with a rotation shaft of the spin chuck.

4. The apparatus of claim 3, further comprising an approaching/separating unit for bringing the first and the second magnet close to or away from each other.

5. The apparatus of claim 4, wherein the approaching/separating unit includes a unit for bringing the first and the second magnet close to each other at the region near the substantially central portion of the substrate.

6. The apparatus of claim 4, further comprising:
arm units for supporting the first magnet and the second magnet such that the first magnet faces one surface of the substrate supported by the spin chuck and the second magnet faces another surface of the substrate; and
a column for supporting the arm units,
wherein the approaching/separating unit has an elevation unit for vertically moving the arm units along the column.

7. The apparatus of claim 3, further comprising a drying gas supply nozzle through which a drying gas is supplied to the substrate,
wherein the first magnet has an opening that opens in the facing direction, and the drying gas supply nozzle is inserted into the opening.

8. A substrate drying method of drying a substrate cleaned by a diamagnetic liquid, comprising:
bringing a magnet unit close to the substrate, the magnet unit being configured to move the liquid adhering to the substrate by means of a magnetic force; and
moving the magnet unit along the substrate toward the edge of the substrate.

9. A substrate drying method of drying a substrate cleaned by a diamagnetic liquid, comprising:
rotating the substrate of a circular plate shape;
bringing a magnet unit close to a region near a substantially central portion of the substrate, the magnet unit being configured to move the liquid adhering to the substrate by means of a magnetic force; and
moving the magnet unit along the substrate from the region near the substantially central portion of the substrate toward a region diametrically outside of the substrate.
